(19) United States
(12) Patent Application Publication
(10) Pub. No.: US 2008/0198522 A1
(43) Pub. Date: Aug. 21, 2008

(54) Device and Method for Supplying Direct Voltage

(75) Inventor: Rune Thomsen, Loegumkloster (DK)

Correspondence Address: MCCORMICK, PAULDING & HUBER LLP, CITY PLACE II, 185 ASYLUM STREET, HARTFORD, CT, 06103, US

(73) Assignee: DANFOSS COMPRESSORS GMBH, Flensburg (DE)

(21) Appl. No.: 11/817,902

(22) PCT Filed: Mar. 1, 2006
(86) PCT No.: PCT/DK06/00120

§ 371 Date: Oct. 25, 2007

(30) Foreign Application Priority Data
Mar. 10, 2005 (DE) 10 2005 011 520.9

(51) Int. Cl. H02H 3/18

(52) U.S. Cl. 361/77

(57) ABSTRACT

The invention relates to a device and method for supplying direct voltage, wherein said device comprises a first connection arrangement (3, 4) for a first direct voltage source (8) and a second connection arrangement (5, 6, 7) for a second direct voltage source (11), wherein the device (1) is provided with a protective element (18) which is connected to the first connection arrangement (3, 4) and prevents a charge equalisation between one direct voltage source (8, 11) and the other direct voltage source (11, 8). The aim of said invention is to ease the direct voltage supply (2) For this purpose the protective element (18) is also connected to the second connection arrangement (5, 6, 7) in order to prevent the defective operation of the device (1) in the case of the reversed polarity of the first direct voltage source (8).

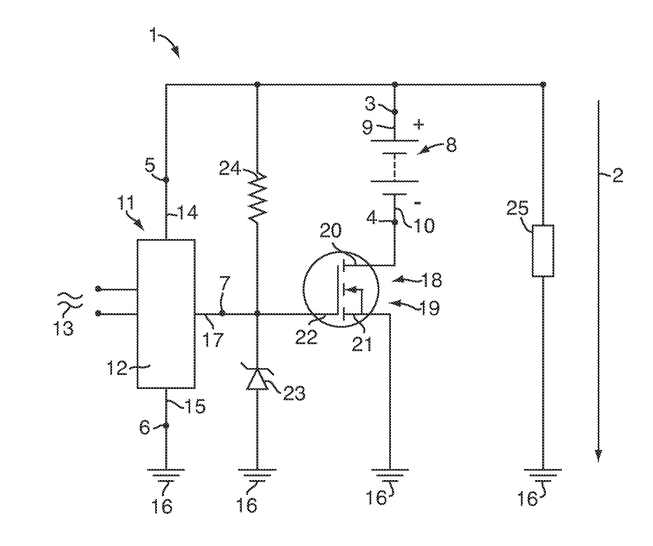

### CROSS REFERENCE TO RELATED APPLICATIONS

This application is entitled to the benefit of and incorporates by reference essential subject matter disclosed in International Patent Application No. PCT/DK2006/000120 filed on Mar. 1, 2006 and German Patent Application No. 10 2005 011 520.9 filed Mar. 10, 2005.

### FIELD OF THE INVENTION

The invention relates to a device for supplying a direct voltage, comprising a first connection arrangement for a first direct voltage source and a second connection arrangement for a second direct voltage source, the device being provided with a protective element which is connected to the first connection arrangement, the protective element preventing a charge equalisation between one direct voltage source and the other direct voltage source. Further, the invention relates to a method for supplying a direct voltage, comprising a first connection arrangement for a first direct voltage source and a second connection arrangement for a second direct voltage source, a protective element being operated at the first connection arrangement and preventing a charge equalisation between one direct voltage source and the other direct voltage source.

### BACKGROUND OF THE INVENTION

Such a device and such a method are known from EP 0 696 832 A2. Here, a direct voltage consumer is supplied by a direct voltage supply device comprising an accumulator and being connectable to an external energy source via a rectifier. The device comprises an electronic switch in the form of a field-effect-transistor which prevents current from the accumulator from reaching the external energy source. Charging and discharging of the accumulator is controlled by a further field-effect-transistor.

In many cases, direct voltage consumers must be supplied with a constant, continuous direct voltage. One example of such an application is vehicles comprising direct voltage consumers. Such vehicles are, for example, trucks, camping vehicles or water vehicles, for example boats. These vehicles have, for example, a compressor for a refrigerator or an air-conditioning system, which are supplied whilst in motion with direct voltage from an accumulator. When the vehicle is in the parked position it is possible to supply the direct voltage consumer in the vehicle from an external direct voltage source instead of the accumulator. This involves the advantage that the accumulator is not unnecessarily discharged. Often an alternating voltage source is available as external energy source, so that firstly the alternating voltage is converted to a direct voltage by a rectifier and then supplied to the electrical direct voltage consumers in the vehicle.

With such devices and methods for supplying a direct voltage it is firstly desirable to ensure a continuous energy supply and secondly to prevent a reversed polarity of the accumulator in the vehicle from causing damage.

JP 09-093 833 shows a device for continuous energy supply that is supplied during normal operation from an external energy source via a rectifier and that supplies a direct voltage consumer. The supplied external voltage is monitored by a voltage monitoring current circuit. In case of a supply failure a field-effect-transistor is switched on, which ensures that an accumulator is connected to the direct voltage consumer, so that a continuous supply of the direct voltage consumer is ensured.

JP 08-308 116 shows a direct voltage source with a connected protecting circuit, protecting a circuit in case of a reversed polarity of the direct voltage source. For this purpose, the protecting circuit comprises a field-effect-transistor controlled by a photocell that is arranged in parallel with the direct voltage source.

### SUMMARY OF THE INVENTION

The invention is based on the task of providing a device and a method simplifying the supply of a direct voltage.

With a device as mentioned in the introduction, this task is solved in that the protective element is additionally connected to the second connection arrangement, the protective element preventing defective operation of the device in case of a reversed polarity of the first direct voltage source.

With this solution it is no longer necessary to use different switching arrangements for a charge blocking function between the first direct voltage source and the second direct voltage source and for a reversed polarity protection of the first direct voltage source. With the protective element these two functions can be combined. Usually the positive connection of a direct voltage source is connected to a positive potential of the connection arrangement, and the negative connection of the direct voltage source is connected to a negative potential of the connection arrangement. If the connections of the direct voltage source should be interchanged, so that different potentials meet, that is, the negative connection of the direct voltage source meets the positive potential of the connection arrangement and vice versa, a reversed polarity occurs. There is then a risk that electrical components and electric circuits are electrically overloaded, resulting in a brief malfunction or permanent damage. With the protective element such overloads, for example a voltage increase, an overheating or a fire, are prevented and defective operation of the device is thus avoided. The protective element can be connected directly to each of the first and second connection arrangements, that is, without a further component being inserted between the protective element and the connection arrangement, or the protective element can be connected indirectly, meaning that further electrical components are available on an electrical path from the protective element to the connection arrangement.

Preferably, the protective element is connected electrically in series to the first direct voltage source. The series connection comprises at least the protective element and the first direct voltage source. The first direct voltage source can, for example, be an accumulator or a battery.

It is preferred that a negative connection of the protective element is connected to the first direct voltage source. The protective element has at least two connections, so that one connection of the protective element is connected to the negative connection of the direct voltage source. Here, connected means that a direct connection exists between the negative pole of the first direct voltage source and the connection of the protective element, or that further components are inserted between the first direct voltage source and the protective element.

Preferably, the protective element is connected to a reference potential of the device. Here, the reference potential of the device means, for example, earth, ground or an intermediary potential.

Advantageously, the second direct voltage source is electrically connected in parallel to a series connection of the first direct voltage source and the protective element. Accordingly, the protective element is connected in series to the first direct voltage source, and these two elements are again connected in parallel to the second direct voltage source. Thus, the first direct voltage source is also connected in parallel to the second direct voltage source. If a direct voltage consumer is connected to this parallel connection, a change of the switching arrangement is not required to select between the first and the second direct voltage supply to ensure supply to the electrical consumer.

It is advantageous that, if both the first direct voltage source and the second direct voltage source are connected, the first direct voltage source is inactive. If both direct voltage sources are available at the same time, it is expedient that the operation by the second direct voltage source is preferred to the first direct voltage source. The second direct voltage source is, for example, an external direct voltage source, whose energy supply is unlimited. In this way the first direct voltage source, which is neither charged nor discharged, is disconnected from the second direct voltage source.

It is preferred that the first direct voltage source has a lower output voltage than the second direct voltage source. In this way a charge equalisation from the first to the second direct voltage source is prevented, even without the protective element. However, without further measures, a charge equalisation from the second direct voltage source to the first direct voltage source takes place.

It is provided that the protective element is a field-effect-transistor with at least one drain connection, at least one source connection and at least one gate connection. A field-effect-transistor is a voltage-controlled electrical component working in a power efficient manner. Field-effect-transistors are available in different embodiments, for example, MOSFET or IGFET. The advantage of a field-effect-transistor is that it can also, without problems, be used as a switch for exact control when switching on or off, that is, when connecting or disconnecting an electrical path.

It is provided that the drain connection of the field-effect-transistor is connected to a negative connection of the first connection arrangement. In this way a reversed polarity protection is easily realised. It is provided that the negative connection of the first direct voltage source is connected to the negative connection of the first connection arrangement. Connecting the positive connection of the first direct voltage source will result in reversed polarity.

It is preferred that the source connection of the field-effect-transistor is connected to a reference potential of the device. A substrate connection branching off from the source connection is thus also connected to the reference potential.

Preferably, the gate connection of the field-effect-transistor is connected to a control outlet of the second direct power source. Here, it has turned out to be favourable for the second direct voltage source to have at least three connections, namely a positive connection, a negative connection and a control outlet. The control outlet imposes a control voltage on the gate connection of the field-effect-transistor.

It is provided that a diode is located between the gate connection of the field-effect-transistor and the reference potential of the device. Diodes of any kind can be used. It is particularly advantageous to use a Zener diode. It is provided that this diode blocks current flow from the gate connection to the reference potential and permits current flow from the reference potential to the gate connection.

In a practical manner an ohmic resistor is located between the gate connection of the field-effect-transistor and a positive connection of the first connection arrangement. The ohmic resistor creates a connection between the positive connection of the first connection arrangement and the gate connection. When the first direct voltage source is mounted, a connection of the first direct voltage source is then connected to the gate connection via the ohmic resistor. The ohmic resistor has a low value, so that the voltage between the gate connection and the source connection of the field-effect-transistor is approximately equal to the voltage supplied by the first direct voltage source. If the polarity of the first direct voltage source is reversed, this is established by means of the voltage between the gate connection and the source connection, and the field-effect-transistor then carries no current at the drain connection.

The task is solved with a method as mentioned in the introduction in that the protective element is at the same time connected to the second connection arrangement, the protective element preventing a defective operation of the device in the case of a reversed polarity of the first direct voltage source.

The fact that the protective element is connected to the first connection arrangement and the second connection arrangement at the same time causes the creation of a connection between the first connection arrangement and the second connection arrangement. In this way it can be monitored, if one of the two direct voltage sources is connected or even both direct voltage sources are available. If two direct voltage sources are available, the protective element ensures that the first direct voltage source is inactive and that the second direct voltage source supplies a direct voltage to the direct voltage consumer. Regardless if the second direct voltage source is available or not, the protective element further establishes, if the first direct voltage source has reversed polarity. The protective element is operated so that no external controller is required for the control of the protective element. A possible control connection on the two direct voltage sources is not regarded as an external connection, but belongs to the device.

It is particularly preferred that the protective element prevents a charge equalisation from the second direct voltage source to the first direct voltage source. A charge equalisation is, for example, a current flow from one direct voltage source to the other direct voltage source. The protective element prevents both a charge equalisation from the first to the second direct voltage source and from the second to the first direct voltage source. In this way the two direct voltage sources work independently of each other, the protective element coordinating which direct voltage source supplies a direct voltage to the direct voltage consumer. In this connection it is favourable, if one direct voltage source is connected and the other direct voltage source is disconnected by means of switching in the protective element. Thus, also an uninterrupted energy supply is ensured.

It is particularly preferred that a control outlet of the second direct voltage source, being connected to a gate connection of a field-effect-transistor serving as protective element, supplies a voltage value to the gate connection in the event that a second direct voltage source is connected. A field-effect-transistor is a suitable protective element since it works efficiently and has at least three connections, at least one of which is connected to the first connection arrangement and at least one being connected to the second connection arrangement. If the gate connection of the field-effect-transistor is connected to the connection arrangement of the second direct voltage source, the field-effect-transistor can firstly establish if the second direct voltage source is available at the second connection arrangement. If this is the case, the field-effect-transistor provides that only the second direct voltage source supplies the direct voltage consumer and that the first direct voltage source is inactive. For this purpose, a voltage, for example a control voltage of the second direct voltage source, can be used, the voltage assuming a value larger than, smaller than or equal to zero. The first direct voltage source remains inactive, until the second direct voltage source is removed. If the first direct voltage source is the only available direct voltage source, it supplies the direct voltage consumer.

### BRIEF DESCRIPTION OF THE DRAWINGS

In the following, the invention is described in detail on the basis of a preferred embodiment with reference to the drawing, showing:

Only FIGURE: is a schematic view of a device for supplying direct voltage.

### DETAILED DESCRIPTION OF THE INVENTION

The only FIGURE is a schematic view of a device 1 for the supply of a direct voltage 2, the device having a first connection arrangement 3, 4 and a second connection arrangement 5, 6, 7. A first direct voltage source 8 is connected to the first connection arrangement 3, 4. Here, the first direct voltage source 8 comprises two units, which are connected to each other. Accessible from the outside are a positive connection 9 and a negative connection 10 of the first direct voltage source 8. The first direct voltage source 8 is electrically connected to the first connection arrangement 3, 4 in such a manner that the positive connection 9 of the first direct voltage source 8 is connected to the positive connection 3 of the connection arrangement 3, 4 and the negative connection 10 of the first direct voltage source 8 is connected to the negative pole 4 of the first connection arrangement. The first direct voltage source 8 is thus connected properly and not with reversed polarity.

A second direct voltage source 11 comprising a rectifier 12 that is supplied from an external alternating voltage source 13 is connected to the second connection arrangement 5, 6, 7. A positive connection 14 of the second direct voltage source 11 is connected to a positive connection 5 of the second connection arrangement 5, 6, 7. A negative connection 15 of the second direct voltage source 11 is connected to a negative connection 6 of the second connection arrangement 5, 6, 7. The negative connection 6 of the second connection arrangement 5, 6, 7 is at the same time connected to a reference potential 16 of the device 1. In the present case the second connection arrangement 5, 6, 7 has a further connection, here used as control connection 7. This control connection 7 is connected to a control outlet 17 of the second direct voltage source 11.

In the present case, the output voltage of the second direct voltage source 11 between the positive connection 5 and the negative connection 6 amounts to 27 Volt. This is also the output voltage of the rectifier 12. In the present case, the output voltage of the first direct voltage source 8 between the positive connection 9 and the negative connection 10 amounts to 12 Volt. Thus, the output voltage of the first direct voltage source 8 is smaller than the output voltage of the second direct voltage source 11. Due to the potential difference, a charge equalisation from the second direct voltage source 11 to the first direct voltage source 8 would take place, if no further measures were taken. However, this is prevented by a protective element 18 in the form of a field-effect-transistor 19 comprising a drain connection 20, a source connection 21 and a gate connection 22. The field-effect-transistor 19 is, for example, of the type 2804 from International Rectifier.

The field-effect-transistor is electrically connected in series to the first direct voltage source 8. The drain connection 20 is connected to the negative connection 4 of the first connection arrangement 3, 4. The source connection 21 is connected to the reference potential 16 of the device 1. The gate connection of the field-effect-transistor 19 is connected to the control connection of the second connection arrangement 5, 6, 7. Between the gate connection 22 and the control connection 7 an electrical connection branches off, which comprises a diode 23, here in the form of a Zener diode and leads to the reference potential 16 of the device 1. The diode 23 blocks current flow from the gate connection 22 in the direction of the reference potential 16. From the gate connection 22 and from the control connection 7 a further electrical connection leads to the positive connection 3 of the first connection arrangement 3, 4 and at the same time to the positive connection 5 of the second connection arrangement 5, 6, 7. In this path an ohmic resistor 24 with a value of 330 KOhm is located in parallel to the series connection of the first direct voltage source 8 and the protective element 18.

In the following, three different modes of operation of the device 1 will be considered. In all three modes of operation the first direct voltage source 8 is connected to the first connection arrangement. In the first mode of operation a second direct voltage source 11 is not available. Thus, no specified voltage is available at the positive connection 5, the negative connection 6 and the control connection 7 of the second connection arrangement 5, 6, 7, so that these connections 5, 6, 7 can assume arbitrary states.

A load 25 is dimensioned for a first direct voltage range between 9.6 and 17 Volts and a second direct voltage range between 21 and 31 Volt. The supply voltages of the first and the second direct voltage sources 8, 11 lie within these ranges, namely about 12 Volts and 24 Volts, respectively. The direct voltages supplied by the first and the second direct voltage sources 8, 11 could, for example, be increased to 48 Volts by a converter, to supply, for example, a compressor as the load 25. The connected load 25 is, for example, one or more direct voltage consumers.

In the first mode of operation the first direct voltage source 8 is connected properly with correct polarity, that is, not reversed polarity, to the first connection arrangement 3, 4. The second direct voltage source 11 is not available. The first direct voltage source 8 provides approximately 12 Volts as output voltage. This causes a current through the ohmic resistor 24 and the diode 23. As the diode 23 with a breakdown voltage of 15 Volts permits practically no passage of current, a voltage drop at the field-effect transistor 19 occurs between the gate connection 22 and the source connection 21. This voltage drop causes the field-effect-transistor 19 to remain in the connected state. In the connected state of the field-effect-transistor 19 a current flows in the field-effect-transistor 19 from the drain connection 20 via the source connection 21 to the reference potential 16. Thus, the first direct voltage source 8 is connected in parallel to a connected load 25, which is continuously supplied with a constant direct voltage by the first direct voltage source 8.

In the second mode of operation the first direct voltage source 8 is connected with reversed polarity to the first connection arrangement 3, 4, and the second direct voltage source 11 is not connected to the second connection arrangement 5, 6, 7. Here, the field-effect-transistor 19 prevents a current flow to the connected load 25. This occurs in that now a negative voltage is available at the field-effect-transistor 19 between the gate connection 22 and the source connection 21. This keeps the field-effect-transistor 19 in a closed state and prevents a current flow from the negative connection 10 of the first direct voltage source 8 to the reference potential 16. A direct voltage 2 is then not available at the load 25. Thus, the connected consumer(s) as the load 25 is(are) protected in the case of reversed polarity of the first direct voltage source 8.

In the third mode of operation of the device 1 the second direct voltage source 11 is connected with an output voltage of 27 Volts to the second connection arrangement 5, 6, 7, as shown in the FIGURE and described above. At its control outlet 17 the second direct voltage source 11 provides a control voltage, which is in the present case zero Volts. The first direct voltage source 8 with an output voltage of 12 Volts is here connected properly with correct polarity, that is, not reversed polarity, to the first connection arrangement 3, 4. As soon as the second direct voltage source 11 is available, the potential at the control connection 7 of the second connection arrangement 5, 6, 7 is kept at zero Volts, so that also the gate connection 22 of the field-effect-transistor 19 assumes a potential of zero Volts. Between the drain connection 20 and the gate connection 22 there are then approximately 15 Volt. This keeps the field-effect-transistor 19 in its disconnected state and a current flow from the drain connection 20 to the reference potential 16 is not possible. This means that at this moment the first direct voltage source 8 is inactive. It is neither discharged, nor is it charged by the second direct voltage source 11. In this mode of operation the load 25 is supplied with a constant direct voltage 2 from the second direct voltage source 11.

All in all, the wiring of the field-effect-transistor 19 prevents a malfunction of the device 1 in the case of a reversed polarity of the first direct voltage source 8 and a charging and discharging of the first direct voltage source 8, when a second direct voltage source 11 is available. Thus, the field-effect-transistor 19 assumes two functions, so that the device 1 for supplying a direct voltage 2 is simplified without neglecting the safety aspects.

Of course, it is also possible that during the anticipated operation the described device 1 is operated by a first direct voltage source 8 without reversed polarity, the positive connection 9 of the first direct voltage source 8 being connected to the protective element 18. Accordingly, also the connections 14, 15 of the second direct voltage source 11 are interchanged, so that the positive connection 14 is connected to the connection 6 and the negative connection 15 is connected to the connection 5 of the second connection device. Here, the reference potential 16 can be maintained, thus assuming a positive potential. It is also possible that at the negative connections 10, 15 of the first and second direct voltage sources 8, 11 the device 1 receives a new reference potential. With such a modified device 1 the blocking and passage functions of the diode 23 and the field-effect-transistor 19 or another protective element have to be adapted to the changed polarity. This can, for example, be done by interchanging the connections of these electrical components. It is also possible to use a different type of field-effect-transistor, which works as described above, however, with changed polarity.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A device for supplying a direct voltage, comprising a first connection arrangement for a first direct voltage source and a second connection arrangement for a second direct voltage source, the device being provided with a protective element which is connected in series with a first connection of the first connection arrangement, wherein the protective element is additionally connected to the second connection arrangement, the protective element being a transistor, whose gate connection is connected to a second connection of the first connection arrangement, thus preventing a defective operation of the device in case of a reversed polarity of the first direct voltage source, the gate connection of the transistor also being connected to a control connection of the second connection arrangement, said control connection blocking the transistor if the second direct voltage source is connected, thus preventing a charge equalisation and a charging or discharging of one direct voltage source to the other direct voltage source.

2. The device according to claim 1, wherein the protective element is connected electrically in series with the first direct voltage source.

3. The device according to claim 1, wherein a negative connection of the protective element is connected to the first direct voltage source.

4. The device according to claim 1, wherein the protective element is connected to a reference potential of the device.

5. The device according to claim 1, wherein the second direct voltage source is electrically connected in parallel to a series connection of the first direct voltage source and the protective element.

6. The device according to claim 1, wherein if both the first direct voltage source and the second direct voltage source are connected, the first direct voltage source is inactive.

7. The device according to claim 1, wherein the first direct voltage source has a lower output voltage than the second direct voltage source.

8. The device according to claim 1, wherein the protective element is a field-effect-transistor with at least one drain connection, at least one source connection and at least one gate connection.

9. The device according to claim 8, wherein the drain connection of the field-effect-transistor is connected to a negative connection of the first connection arrangement.

10. The device according to claim 8, wherein the source connection of the field-effect-transistor is connected to a reference potential of the device.

11. The device according to claim 8, wherein the gate connection of the field-effect-transistor is connected to a control outlet of the second direct power source.

12. The device according to claim 8, wherein a diode is located between the gate connection of the field-effect-transistor and the reference potential of the device.

13. The device according to claim 8, wherein an ohmic resistor is located between the gate connection of the field-effect-transistor and a positive connection of the first connection arrangement.

14. A method for supplying a direct voltage with a device comprising a first connection arrangement for a first direct voltage source and a second connection arrangement for a second direct voltage source, a protective element being connected to and operated in series with a first connection of the first connection arrangement, wherein the protective element being a transistor, whose gate connection is connected to a second connection of the first connection arrangement, thus preventing a defective operation of the device in the case of a reversed polarity of the first direct voltage source, the gate connection of the transistor also being connected to a control connection of the second connection arrangement, said control connection blocking the transistor if the second direct voltage source is connected, thus preventing a charge equalisation and a charging or discharging of one direct voltage source to the other direct voltage source.

15. The method according to claim 14, wherein the protective element prevents a charge equalisation from the second direct voltage source to the first direct voltage source.

16. The method according to claim 14, wherein a control outlet of the second direct voltage source, being connected to a gate connection of a field-effect-transistor serving as protective element, supplies a voltage value to the gate connection which is dependent upon a connected second direct voltage source.
